(19) United States
(12) Patent Application Publication
(10) Pub. No.: US 2003/0094025 A1
(43) Pub. Date: May 22, 2003

(54) Method and apparatus for locking a storage device

(75) Inventor: Brian L. Dallman, Weaverville, NC (US)

Correspondence Address: BAKER & HOSTETLER LLP, Washington Square, Suite 1100, 1050 Connecticut Avenue, N.W., Washington, DC, 20036, US

(73) Assignee: SPX Corporation

(21) Appl. No.: 09/988,328

(22) Filed: Nov. 19, 2001

(51) Int. Cl. E05B 49/00

(52) U.S. Cl. 70/278.1

(57) ABSTRACT

A lock apparatus and method for storage devices such as refrigerators that can be operated without the user needing to carry a separate key. The apparatus has a refrigerated housing, a pivoting door that is movable between a closed position an open position, and a combination lock mounted to the door or housing that locks the door in the closed position and that can be activated via entering a combination to unlock the combination lock and permit opening of the door.

### FIELD OF THE INVENTION

The present invention relates generally to a method and apparatus for locking a storage device. More particularly, the present invention relates to a locking method and apparatus where the storage device is an enclosure, for example, a refrigerator.

### BACKGROUND OF THE INVENTION

Storage devices such as refrigerators are used in many applications where it would be desirable to have a lock associated with the door of the storage device to restrict access to the materials inside. For example, in the case of a laboratory refrigerator, it is useful to limit access to the materials such as pharmaceuticals, specimens, or other precious and/or hazardous materials that might be stored in the refrigerator. It is also sometimes desirable to limit the number of times a laboratory refrigerator is opened to reduce contamination of the materials inside and/or help maintain a constant temperature.

In the case of a laboratory refrigerator that has a spring action catch releasable by a handle, or a swing cam locking latch, also with a handle, it has been known to provide either a built-in keyed lock or a removable padlock.

However, the use of a keyed lock has several disadvantages. First, this type of lock requires that authorized users of the refrigerator carry keys with them, and in laboratory environments it may not be desirable for users to be required to carry separate items such as keys with them. Second, when it is desired to change the personnel who have access to the refrigerator, it is necessary that new keys be distributed, or the currently used keys be returned, and if all the keys are not returned, the lock tumblers must be replaced and new keys be distributed, which is time consuming and expensive. Also, it is necessary to open the refrigerator door in order to replace parts of the keyed lock which can cause unwanted contamination of, or temperature variation of, the materials inside the refrigerator. Further, if a key inadvertently is lost or inadvertently is left where it can be found, the finder of the key may try the key in the lock and thus an unauthorized user may be able to open the refrigerator.

Removable padlocks also have disadvantages. For example the removable lock may become misplaced and/or may be damaged by being dropped.

Accordingly, it would be desirable to have a lock apparatus and method for storage devices such as refrigerators that can be operated without the user needing to carry a separate key, and/or that can be easily changed so that different users have access to the inside of the storage device.

### SUMMARY OF THE INVENTION

It is therefor a feature and advantage of the present invention to provide a lock apparatus and method for storage devices such as refrigerators that can be operated without needing to carry a separate key.

It is another feature and advantage of the present invention to provide a lock apparatus and method for storage devices such as refrigerators that can be easily changed so that different users have access to the inside of the storage device.

It is another feature and advantage of the present invention to provide a lock apparatus and method for storage devices such as refrigerators that is built into the storage device.

The above and other features and advantages are achieved through the use of a novel lock apparatus and method as herein disclosed. In accordance with one embodiment of the present invention, an apparatus for storing products has a refrigerated housing, a pivoting door that is movable between a closed position an open position, and a combination lock fixedly mounted to the door or housing that locks the door in the closed position and that can be activated via entering a combination to unlock the combination lock and permit opening of the door.

In accordance with another embodiment of the present invention, an apparatus for storing products, has a refrigerated housing, a pivoting door that is movable between a closed position and an open position and means mounted to one of the door and the housing for selectively locking the door closed and for selectively unlocking the door upon entering a combination to unlock the combination lock and permit opening of the door; and means for fixedly mounting the locking means to one of the door and the housing.

In accordance with another embodiment of the present invention, a method for selectively locking and unlocking a door of a laboratory refrigerated storage device is providing having the steps of inputting a combination code into a combination lock fixedly mounted to the door and/or the housing, verifying whether the input combination code corresponds to a preset lock code, releasing the combination lock when the input code corresponds to the present code; and opening the door to permit access to the inside of the refrigerated storage device.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a perspective partial view of a laboratory refrigerator having a lock system installed.

FIG. 2 is a front view of the locking system installed on a door.

FIG. 3 is a cross-sectional view showing a door edge with a lock system installed.

FIG. 4 is a front view of a laboratory refrigerator having a lock system installed.

### DETAILED DESCRIPTION OF PREFERRED EMBODIMENTS OF THE INVENTION

A preferred embodiment of the invention provides a lock apparatus and method for storage devices such as laboratory refrigerators that can be operated without needing the user to carry a separate key, and/or that can be easily changed so that different users have access to the inside of the storage device.

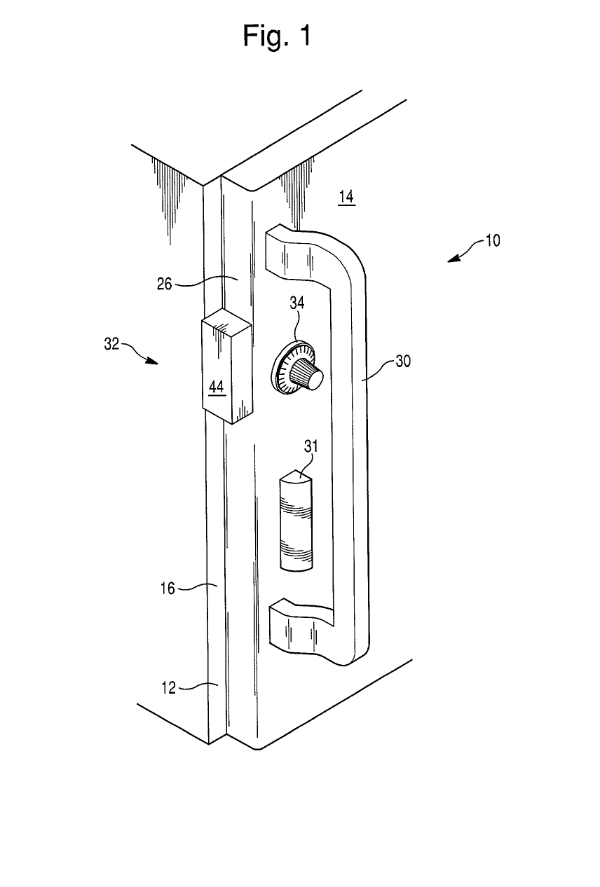

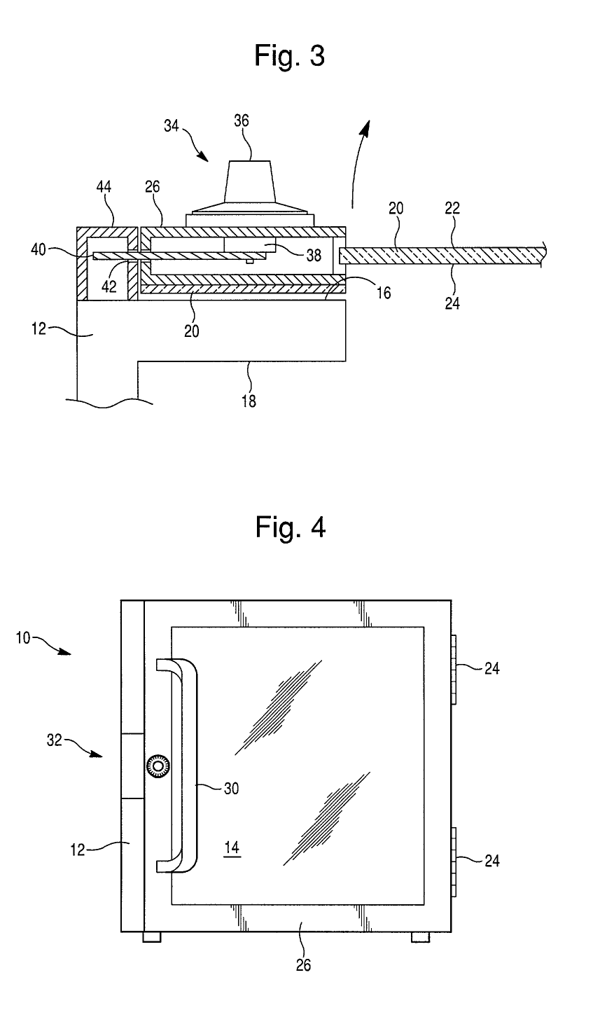

FIGS. 1 through 4 illustrate a laboratory refrigerator 10 having a housing 12 and a pivoting door 14. As seen in FIGS. 3 and 4, the housing 12 includes an outer surface wall 16 and an inner surface wall 18, and the door 14 includes a glass panel 20 having an outer surface 22 and an inner surface 24. The glass panel 20 is surrounded around its periphery by a metal door surround structure 26, which is a generally u-shaped channel.

Insulation 20 is provided to seal between the door 14 and wall 16. The insulation 18 may be attached to the surround 26 as shown. The door 14 is attached by hinges 24 so that it can be opened and closed. A handle 30 may also be provided on the door 14 to facilitate opening and closing the door 14.

The door 14 may also include a conventional door latch assembly and handle arrangement 31 (shown in FIG. 1) which can interact with a slot or suitable striker plate on the housing 12 when the door 14 is closed. The latch and handle can be, for example, of the spring assisted type, cam-operated type and/or over-center type.

FIGS. 1 through 3 also depict a combination type locking system 32 that is used to lock the door 14 shut. The locking system 32 includes a combination lock device 34, which in a preferred combination has a dial 36, associated conventional combination lock components in a lock assembly 38, and a rotating latch bolt 40. The latch bolt 40 fits in a striker slot 42 on a striker box 44 mounted on the housing 12.

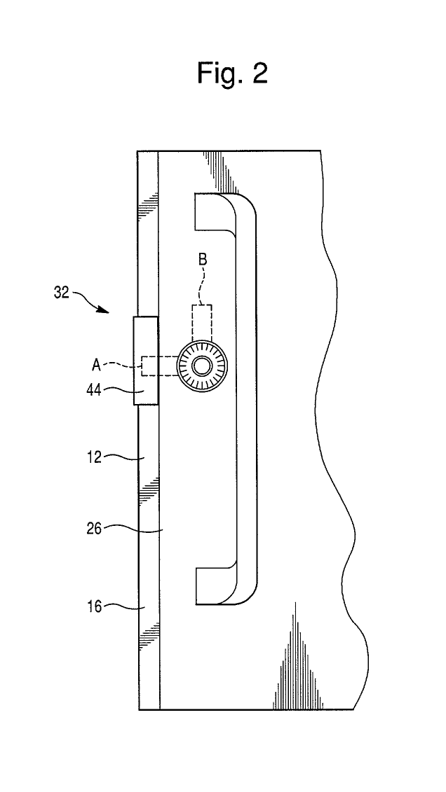

As shown in hidden lines in FIG. 2, the latch bolt 40 is moveable between a locked position A and an unlocked position B. In the unlocked position B, the latch bolt 40 is retracted fully into the door and the door 14 is permitted to be opened and closed. In the locked position A, the latch bolt 40 extends outwardly from the edge of the door 14 and can fit within the striker slot 42 to lock the door 14 shut and prevent it from being opened.

To lock the door 14, the user can simply rotate the dial 36 when the door 14 is closed. In some embodiments, the user can also activate the lock system 32 to lock it when the door 14 is open prior to being closed. After the door 14 has been locked shut, in order to open the door 14, the user must unlock the lock system 32 by manually operating the dial 36 on the combination lock 34 to retract the lock bolt 40.

In a preferred embodiment the user follows these steps to unlock the lock system 32. First, the user clears the combination lock 34 by rotating the dial 36 several times in one direction, then rotating the dial 36 first in the one direction to a first number, back in the opposite direction to a second number, and then back in the first direction to a third number. The rotations cause indication of three combination numbers, and when the three numbers input correspond to the combination of the lock 34 the lock is released. At this point the user further rotates the dial 36, which retracts the locking bolt 40 so that the door 14 can be opened. Although a dial-type lock assembly is shown, any suitable combination type lock can be used.

By virtue of this arrangement, one or more users may be given access to the inside of the refrigerator by distributing to them the three combination numbers. The number can be distributed either orally, in writing, by electronic mail, or by any other suitable distribution mechanism. In this way, it is possible for one or a selected number of users to have access to the lock. The numbers can be renumbered and the record of the combinations destroyed, hidden or kept securely, which can reduce the likelihood of an unauthorized user being able to open the refrigerator, compared to an actual key that can be more easily found or stolen. It is thus possible to destroy written records of the numerical combinations or to store them securely so that the combination will not in inadvertently fall into the hands of unauthorized users.

In the preferred embodiment, the combination numbers are resettable if desired. In order to change the authorized users, an operator may manipulate the combination lock to reset the numbers to a different set of numbers. This can be accomplished in various ways with conventional combination lock arrangements. For example, when the lock is in the unlocked/retracted state, it may be possible to initiate a reset by, for example, pushing in on the dial or sending some other signal to set the lock into a learning mode. In the learning mode, the user rotates the dial to input the three numbers that will then form the new combination. It will be appreciated that as long as this new combination is not distributed to someone who was formerly an authorized user, that user now becomes unauthorized even without a requirement that the key be retrieved from them or the need to replace any mechanical part of the lock.

Although in the preferred embodiment, a rotary single dial combination lock is shown, it is envisioned that any type of appropriate combination lock may be used. For example, the combination lock may have three or more individual rotatable elements such as individual dial wheels that are each settable to a number.

Suitable combination locks can also be electronic instead of mechanical, and can feature a multi-digit keypad, or alphanumeric or symbolic keypads and a display. The combination lock can also be a push-button type of lock having several push-buttons that must be activated in a certain sequence in order to release the lock. Numeric combinations, alphabetic combinations or other combinations can be used.

In the preferred embodiment, the lock assembly 38 is connected to the latch bolt 40 and extends the latch bolt 40 into a slot 42. It is sometimes desired to have an additional latch assembly arrangement such as latch 31 in FIG. 1 to provide positive closure even when the lock is not locked. In such cases, the combination lock assembly 38 may be incorporated to interact directly with the latch mechanism 31 itself so that rather than extending a separate latch bolt into a striker plate, the combination lock assembly 38 instead may extend a bolt or other element into part of the latch arrangement assembly 31 to impede movement of the latch arrangement and therefore prevent a user from opening the door by using the latch 31. In other embodiments, latch 31 may be omitted. This provides a benefit of simplicity because the lock assembly 38 can function both as a lock and as the primary device that holds the door shut.

In the preferred embodiment, the rotary dial 36, the combination element parts 38 and latch bolt 40 are described as being fixedly mounted to the door 14 with the strike slot 42 being on the housing 12. However, in other embodiments, the dial 36, combination components 38 and the latch bolt 40 may be incorporated fixedly in the housing 12 instead and the strike slot 42 can be provided on the door 14.

The many features and advantages of the invention are apparent from the detailed specification, and thus, it is intended by the appended claims to cover all such features and advantages of the invention which fall within the true spirits and cope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for storing products, comprising:
a refrigerated housing;
a pivoting door that is movable between a closed position and an open position; and
a combination lock fixedly mounted to one of the door and the housing, that locks the door in the closed position, and that is activated via entering a combination to unlock the combination lock and permit the opening of the door.

2. An apparatus according to claim 1, wherein the lock has a combination, and the combination can be selectively changed to a different combination by the user.

3. An apparatus according to claim 1, wherein the combination lock is a rotary dial type having a single dial.

4. An apparatus according to claim 1, wherein the combination lock is a multiple dial type.

5. An apparatus according to claim 1, wherein the combination lock is a push button type.

6. An apparatus according to claim 1, wherein the combination lock is an electronic lock having a digital keypad.

7. An apparatus according to claim 1, wherein the combination lock is mounted to the door.

8. An apparatus according to claim 1, wherein the combination lock is mounted to the housing.

9. An apparatus for storing products, comprising:
a refrigerated housing;
a pivoting door that is movable between a closed position and an open position; and
means mounted to one of the door and the housing for selectively locking the door closed and for selectively unlocking the door upon entering a combination to unlock the combination lock and permit opening of the door; and
means for fixedly mounting the locking means to one of the door and the housing.

10. An apparatus according to claim 9, wherein the locking means has a combination, and the combination can be selectively changed to a different combination by the user.

11. An apparatus according to claim 9, wherein the locking means is a rotary dial type having a single dial.

12. An apparatus according to claim 9, wherein the locking means is a multiple dial type.

13. An apparatus according to claim 9, wherein the lock means is a push button type of lock

14. An apparatus according to claim 9, wherein the locking means is mounted to the door.

15. An apparatus according to claim 9, wherein the locking means is mounted to the housing.

16. An apparatus according to claim 9, wherein the locking means is an electronic lock having a digital keypad.

17. A method for selectively locking and unlocking a door of a laboratory refrigerated storage device, comprising the steps of:
inputting a combination code into a combination lock fixedly mounted to the door and/or the housing;
verifying whether the input combination code corresponds to a preset lock code;
releasing the combination lock when the input code corresponds to the present code; and
opening the door to permit access to the inside of the refrigerated storage device.

18. A method according to claim 17, further comprising the step of resetting the preset code to a new code by inputting the new code.

19. A method according to claim 18, wherein the step of inputting the new code comprises the step of rotating a dial.

20. A method according to claim 18, wherein the step of inputting the new code includes the step of depressing one or more buttons in sequence.

21. A method according to claim 18, wherein the step of inputting the code comprises the step of inputting a set of digits via an electronic keypad.
